(19) United States
(12) Patent Application Publication
(10) Pub. No.: US 2009/0144882 A1
(43) Pub. Date: Jun. 11, 2009

(54) Hat note method and device

(76) Inventor: Wayne Brian Neri, Wallkill, NY (US)

Correspondence Address: BARBER LEGAL, P.O. BOX 16220, GOLDEN, CO, 80402-6004, US

(21) Appl. No.: 11/999,540

(22) Filed: Dec. 6, 2007

(51) Int. Cl. A42B 1/24; A42B 1/00; G09F 3/00

(52) U.S. Cl. 2/209.13; 2/195.1; 40/329

(57) ABSTRACT

A billed hat having a writing material such as paper attached to the bill by tacky adhesive. The note paper, card stock or the like may be instantly removed and inserted into any other billed hat, even billed hats lacking any structures such as clips or studs, as the adhesive alone is sufficient to hold the writing material onto the hat. The writing material may be generally shaped and sized like the bill of a hat, with a rounded top and a width similar to that of the hat bill width. The adhesive is preferably a tacky one, allowing one note paper to be removed and emplaced in multiple different places not limited to hats.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### CROSS-REFERENCE TO RELATED APPLICATIONS

N/A

### FIELD OF THE INVENTION

This invention relates generally to hats, and specifically to hats having note taking equipment therein.

### STATEMENT REGARDING FEDERALLY FUNDED RESEARCH

This invention was not made under contract with an agency of the US Government, nor by any agency of the US Government.

### BACKGROUND OF THE INVENTION

It frequently occurs when working, doing errand or just playing out of doors that note taking becomes necessary. For example, while a carpenter is working, he may suddenly need to jot down a number of dimensions in order to make sure that he remembers the dimensions of an item to be cut. At such times it is frequently annoying to have to juggle a pen, paper, clip-board and also tools. PDAs present substantially the same issue, as do notebooks and the like. Even carrying around note-taking materials is enough of a hindrance that most people do not carry paper everywhere they go during the day.

Large numbers of people wear hats. Thus combining writing materials with hats becomes a potentially desirable option in a number of cases.

Professional searching in the collection of the US Patent and Trademark Office reveals a number of items featuring some form of note taking on hats. However, most of these more or less consist of tucking or clipping writing materials into a hat band or the like.

U.S. Pat. No. 6,477,714, issued Nov. 12, 2002 to Boatwright at least teaches that a paper or note or the like may be attached to a hat bill, however, the '714 item is typical of prior art teaching in that the '714 item teaches a permanent clip attached to the hat, with all the concomitant structures such as studs through the bill of the hat and so on.

Significantly, the device and method of the '714 patent are permanent additions to the hat, meaning that the invention cannot be more or less instantly transferred from one '714 hat to another. Either a laborious process of ripping studs out of one hat and putting them into another would be necessary, or else the '714 device would have to be replicated for each hat it is used on. The present invention uses different structures and thus avoids these problems.

US Design Patent D488292 issued Apr. 13, 2004 to Haggberg teaches a golf hat using the hat bill to hold numerous pockets dimensioned and configured to hold golf tees. It is not obviously related to the present invention other than in its use of the bill of the hat for a different structure and purpose.

U.S. Pat. No. 5,253,368 issued Oct. 19, 1993 to Blake teaches another design for attaching the writing materials to the crown of the hat rather than the bill. The '368 reference, like the '714 reference, teaches a permanent addition to the hat, and like the '714 reference does not seem to offer an easy structure to transfer/remove/install the device. By using different structures the present invention offers the use of any hat without any clip or permanent emplacement on the hat.

U.S. Pat. No. 5,687,496 issued Nov. 18, 1997 to McEnroe at least offers structures which are not permanent emplacements to the hat, however, the device of McEnroe is not operable with the bill of a hat. Instead it hangs from the webbing on the interior of a construction helmet crown, and thus teaches firmly away from attachment to a hat crown.

Finally, a number of items in the US Patent and Trademark Office collection display more typical hat brim, hat band, hat crown clips and the like. The addition of structures to the hat itself is not necessary in the present invention, which affords a firm writing surface by using the bill of the hat

It would be preferable to provide a method and device which offers structures not necessarily permanently attached to the hat, yet which cooperates with the crown to provide a firm writing surface and is quickly and easily transferred from hat to hat.

### SUMMARY OF THE INVENTION

General Summary

A billed hat having a writing material such as paper attached to the bill by tacky adhesive. The writing material may be note paper, card stock or the like. The adhesive is preferably tacky, so that the writing material may be instantly removed and inserted into any other billed hat, even billed hats lacking any preparation structures such as clips or studs, as the adhesive alone is sufficient to hold the writing material onto the hat. Unlike reference designs such as that of the '714 reference, the invention may consist of only the writing material, adhesive and hat.

The writing material may be generally shaped and sized like the bill of a hat, with a rounded top and a width similar to that of the hat bill width. In other embodiments, the writing material may be more closely tailored to the shape of a specific hat bill.

The adhesive is preferably a tacky one, allowing one note paper to be removed and emplaced in multiple different places not limited to hats, however, other adhesives may be used.

Summary in Reference to Claims

It is therefore another aspect, advantage, objective and embodiment of the invention, in addition to those discussed previously, to provide an improved hat having a bill, wherein the improvement comprises:

a piece of writing material and adhesive adhered to such hat bill.

It is therefore another aspect, advantage, objective and embodiment of the invention to provide an improved hat bill wherein the writing material further comprises:

a planform having a curved top section.

It is therefore another aspect, advantage, objective and embodiment of the invention to provide an improved hat bill wherein the writing material further comprises one member selected from the group consisting of:

card stock, paper and combinations thereof.

It is therefore another aspect, advantage, objective and embodiment of the invention to provide an improved hat bill further comprising:

indicia of advertising on the writing material.

It is therefore another aspect, advantage, objective and embodiment of the invention to provide an improved hat bill wherein the planform further comprises:

a curved bottom section.

It is therefore yet another aspect, advantage, objective and embodiment of the invention to provide an improved hat bill wherein the improvement consists essentially of:

a piece of writing material and adhesive adhered to such hat bill.

It is therefore another aspect, advantage, objective and embodiment of the invention to provide an improved hat bill wherein the writing material further comprises:

a planform having a curved top section.

It is therefore another aspect, advantage, objective and embodiment of the invention to provide an improved hat bill wherein the writing material further comprises one member selected from the group consisting of:

card stock, paper and combinations thereof.

It is therefore another aspect, advantage, objective and embodiment of the invention to provide an improved hat bill further comprising:

indicia of advertising on the writing material.

It is therefore another aspect, advantage, objective and embodiment of the invention to provide an improved hat bill wherein the planform further comprises:

a curved bottom section.

It is therefore another aspect, advantage, objective and embodiment of the invention to provide a method of taking notes, comprising:

providing a hat having a bill, the bill having a planform;

providing a piece of writing material having a planform specifically dimensioned and configured to fit within the planform of the bill;

adhering the piece of writing material to the bill by means of adhesive; and

taking notes on the piece of writing material while it is adhered to the bill.

### BRIEF DESCRIPTION OF THE DRAWINGS

FIG. 1 is a bottom view of a first embodiment of the device on a hat, showing the device in use with advertising and notes.

FIG. 2a is a planform view of a second embodiment of the device.

FIG. 2b is a planform view of a third embodiment of the device.

FIG. 2c is a planform view of a fourth embodiment of the device.

FIG. 3 is a top view a fifth hat embodiment of the device.

FIG. 4 is a bottom view of an embodiment of the device in use on a hat having a different shape of bill.

### INDEX OF REFERENCE NUMERALS

Crown 102
Bill 104
Note device/writing material 106
Notes 108,110,112
Advertisement 114
Crown 302
Bill 304
Gore 320
Seam 322
Insignia 324
Straps 326a, 326b
Fastener 328
Crown 402
Bill 404
Writing material 406
Gore 420

### DETAILED DESCRIPTION

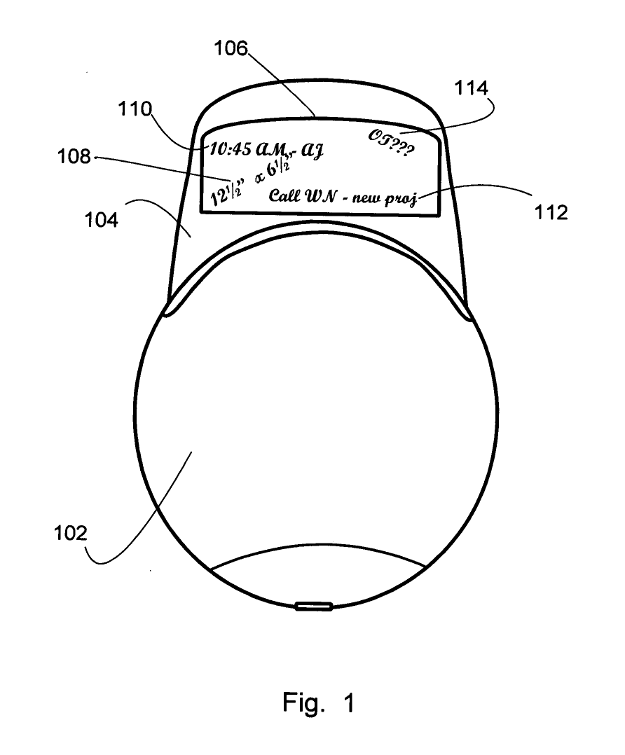

FIG. 1 is a bottom view of a first embodiment of the device on a hat, showing the device in use with advertising and notes. In the presently preferred embodiment and best mode presently contemplated for carrying out the invention, hat crown 102 is not necessary for securing writing materials to the hat, and neither are bands around the hat, clips and similar expedients seen in the prior art. Bill 104 has adhered thereto note device/writing material 106. Not visible from beneath is the adhering device, which may advantageously be a tacky adhesive, but may also be less tacky adhesives and so on. The side seen is the writing side in this view, although since the adhesive is likely to be substantially transparent, it is difficult to see even on the tacky side.

Tacky adhesives offer one of the greatest advantages of the method over the prior art. The card stock writing material can be instantly removed from any one hat (leaving an entirely ordinary hat with nothing unusual thereon) and placed onto the bill of another hat, even though the other hat has no special equipment prepared for receiving papers. For example, a single note could be adhered under the brim of a baseball style hat, then removed instantly and equally instantly placed under or on top of the bill of a policeman's hat, then removed yet again and attached to the edge of a computer monitor.

Notes 108, 110, 112 may be seen to be any type of note at all. Dimensions of work being done (for example, carpentry, wiring, roofing, plumbing, flooring and other construction, renovation, maintenance or repair work) may be made, as may notes of meetings and appointments, “To Do” notes or any other type of note.

Advertisement 114 may be placed on the writing material as well, so as to reduce costs of the device. Indicia of advertising may take a number of forms including printed matter, buttons, free samples, small devices and so on. Note that in the preferred embodiments, advertising size is strictly limited so as to provide generous room for note taking by final users. Smaller advertisements may accomplish this. “Watermark” style advertisements which are very faintly printed may also accomplish this, as may removable advertising devices.

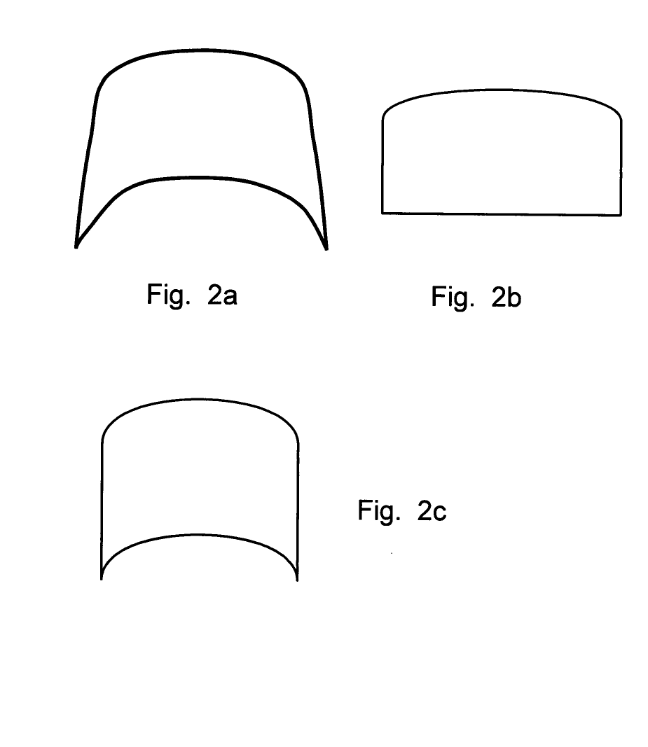

FIG. 2a is a planform view of a second embodiment of the device, showing the underside and adhesive thereon. While adhesive is shown all around the periphery in this embodiment, the adhesive is more preferably placed over a substantial area or the entire area of the device.

The alternative embodiment of FIG. 2a has a planform which is very closely dimensioned and configured to the shape of a hat bill. As shown in FIG. 2a, the embodiment includes a rounded top periphery having a radius of curvature approximately equal to the radius of curvature of a hat bill, a width and length approximately equal to the width and length of a hat bill, a rounded bottom periphery having a radius of curvature approximately equal to the radius of curvature of the crown at the join of the crown and bill (which may be regarded as approximately equal to the radius of curvature of the typical forehead), and thus two extensions downwards from the main body.

FIG. 2b is a planform view of a third embodiment of the device. This presently embodiment and best mode now contemplated has a simpler shape in planform, a shape well suited to a wide variety of hats. FIG. 2c is a planform view of a fourth embodiment of the device, suited to a different shape of bill than the embodiment of FIG. 2a.

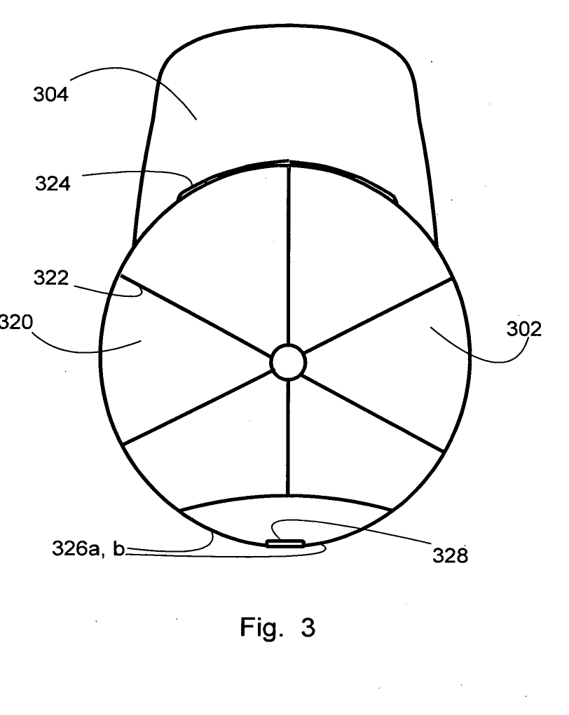

FIG. 3 is a top view a fifth hat embodiment of the device. The device of the invention is not visible from the top view (nor from side views) when the device is in use on the bottom of the bill of the cap. (If used on the top of the bill, the device is not visible from the bottom and extremely inconspicuous in side views.) Unlike prior art devices, the hat of the invention does not materially alter the appearance of the hat.

FIG. 3 also shows that a normal “baseball” style hat may have all normal features of such hats. Crown 302 may be manufactured from a plurality of individual gores 320 stitched at seam 322 with bill 304 attached on one side.

Insignia 324 such as patches may also be used on the hat without any loss of esthetic appeal from the improvement of the invention. Straps 326a, 326b may have fastener 328 (hook-and-loop fabric, matching rows of studs and hole, buckles, buttons, etc) to allow adjustment of the hat to different sizes without impediment from the invention.

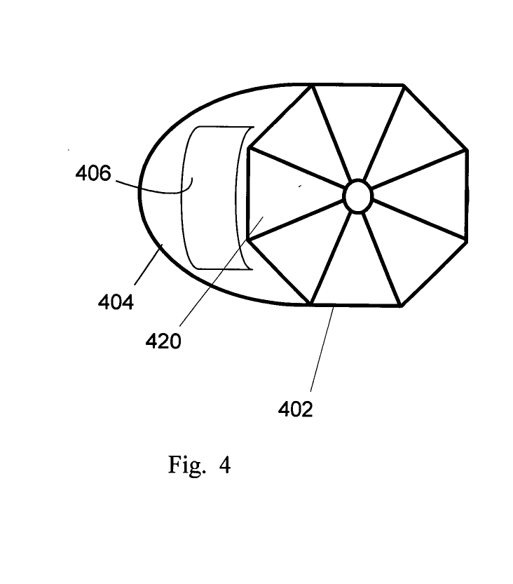

FIG. 4 is a bottom view of an embodiment of the device in use on a hat having a different shape of bill. Crown 402 (of gores 420) and bill 404 may be different shapes from those of the embodiments of FIGS. 1 and 3, yet writing material 406 may still be used. Cowboy hats, straw hats, sombreros, uniform hats, fire helmets and any other type of hat or cap having a brim may thus be used as the basal hat of the improvement of the invention.

Unlike any prior art, when a user is writing on the writing material of the invention, the hat bill serves as firm writing surface, thus eliminating need for a separate clip board, note pad backing or other writing surface. This is yet another structural difference of the invention from the prior art.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

What is claimed is:

1. An improved hat having a bill, wherein the improvement comprises:
a piece of writing material and adhesive adhered to such hat bill.

2. The improved hat of claim 1, wherein the writing material further comprises:
a planform having a curved top section.

3. The improved hat of claim 1, wherein the writing material further comprises one member selected from the group consisting of:
card stock, paper and combinations thereof.

4. The improved hat of claim 1, further comprising:
indicia of advertising on the writing material.

5. The improved hat of claim 1, wherein the planform further comprises:
a curved bottom section.

6. An improved hat, wherein the improvement consisting essentially of:
a piece of writing material and adhesive adhered to such hat bill.

7. The improved hat of claim 6, wherein the writing material further comprises:
a planform having a curved top section.

8. The improved hat of claim 6, wherein the writing material further comprises one member selected from the group consisting of:
card stock, paper and combinations thereof.

9. The improved hat of claim 6, further comprising:
indicia of advertising on the writing material.

10. The improved hat of claim 6, wherein the planform further comprises:
a curved bottom section.

11. A method of taking notes, comprising:
providing a hat having a bill, the bill having a planform;
providing a piece of writing material having a planform specifically dimensioned and configured to fit within the planform of the bill;
adhering the piece of writing material to the bill by means of adhesive; and
taking notes on the piece of writing material while it is adhered to the bill.
